(19) United States
(12) Patent Application Publication
(10) Pub. No.: US 2005/0171681 A1
(43) Pub. Date: Aug. 4, 2005

(54) Method and system for preventing rear end collision of vehicles

(76) Inventors: Tianshu Yang, Beijing (CN); Liu Yang, Beijing (CN)

Correspondence Address: KAPLAN & GILMAN , L.L.P., 900 ROUTE 9 NORTH, WOODBRIDGE, NJ, 07095, US

(21) Appl. No.: 11/062,085

(22) Filed: Feb. 18, 2005

Related U.S. Application Data
(63) Continuation-in-part of application No. PCT/CN02/00575, filed on Aug. 19, 2002.

(51) Int. Cl. G06F 19/00

(52) U.S. Cl. 701/116; 123/198 DB

(57) ABSTRACT

A kind of method and system for preventing rear end collision of vehicles are intended to apply to the vehicles equipped with the electric fuel injection system. By using a fuel-decreasing pre-warning electric control unit standing for PW-ECU, the throttle value D of the engine can be obtained through sampling from the throttle sensor 1 of the electric fuel injection system in real time. Do time differential operation to the throttle value D to get the throttle speed value Rₜ, then comparing the throttle speed value Rₜ with a preset fuel-decreasing pre-warning value Rₚ. If Rₜ equal to or exceed the preset value Rₚ when the engine decreases the fuel, the pre-warning devices 7 driven by PW-ECU will send out the pre-warning signals to the following vehicles. Therefore we can realize preventing rear end collision of the vehicles by the fuel-decreasing pre-warning method. At same time we provide a system for preventing rear end collision of the vehicles by the fuel-decreasing pre-warning method.

### RELATED APPLICATION

This is a continuation-in-part of International Application PCT/CN2002/000575, with an international filing date of Aug. 19, 2002.

### TECHNICAL FIELD OF THE INVENTION

This invention mainly relates to fuel-decreasing pre-warning method and system used for preventing rear end collision of vehicles.

### BACKGROUND OF THE INVENTION

The importance of preventing rear end collision of vehicles and the difficulty of solving this problem are widely known. At present one of an efficient method for preventing the rear end collision is that when the leading vehicle urgent braking it should send out a deceleration pre-warning signal to the following vehicle in advance. But the technical difficulty of this method is how to get the “pre-warning control signal” in advance. All the public techniques have studied and focused on how to install a sensor that can detect the deceleration signal on the vehicles and then they can use the sensor to get the “pre-warning control signal”. In the CN97250985 a potentiometer used as the sensor is installed on the throttle valve to detect the fuel-decreasing speed. In the CN99211066 the two photoelectric switches mounted on the body of the vehicles and reflector mounted on the accelerator pedal is used to detect the fuel-decreasing speed. In the US005387898A the piezoelectric crystal and the inertia block mounted on the accelerator pedal rod are used to detect the deceleration value of the accelerator pedal rod. In the U.S. Pat. No. 6023221 the longitudinal deceleration value is detected by the acceleration sensor installed on the vehicle. In the U.S. Pat. No. 6278364 the magnetic and electric sensor is used to detect the speed of the wheels and then the deceleration value is calculated by the computer and finally the “pre-warning control signal” can be got.

But in the practice, the most difficulty encountered by these techniques is that how to design the deceleration sensor for all kinds of vehicles and then install the sensor on the cars. Therefore, it is difficult to popularize and widely use these techniques for preventing rear end collision of vehicles.

### SUMMARY OF THE INVENTION

An object of the invention is to provide a pre-warning method for preventing the rear end collision of vehicles which getting the pre-warning control signal through utilizing existing sensor and the equipments have been installed on the vehicles to avoid the installation problem of the sensor and the pre-warning operation can be done quickly and timely.

Another object of the invention is to provide a system for preventing rear end collision of the vehicles by the fuel-decreasing pre-warning method.

When existing “deceleration pre-warning” techniques meet difficulty, this invention found out a novel method of “fuel-decreasing pre-warning” from the electric fuel injection technique domain and the “fuel-decreasing pre-warning” novel method is realized on the foundation of the electric fuel injection system.

Since the first engine electric fuel injection system is developed by the BOSCH company in 1967, at present, all the new vehicles have installed the electric fuel injection system because of this system having the excellent and prominent effect on the fuel saving and exhaust gas discharge aspects.

This electric fuel injection system can early know the driver's attempt to accelerate or decelerate the vehicle before a change of the vehicle's speed. This reasons analysis as below:

The electric accelerator pedal sensor, the throttle valve position sensor, the air flow meter, other sensors concerned with the fuel injection quantity and the computers are mounted on the electric fuel injection system in order to achieve the excellent burning effect and excellent control performance. The air input quantity is measured by the system firstly, then the fuel injection quantity is calculated quickly, so that the system can response quickly to the driver's operation on vehicle speed. The increase or the decrease of the fuel injection quantity will indicate the acceleration or the deceleration of the vehicles. Therefore, this system can early know the driver's attempt to accelerate or decelerate the vehicle. According to this analysis, we can conclude that if the throttle speed value Rₜ detected by the sensor of the electric fuel injection system equal to or exceed the preset value Rₚ when the engine decreases the fuel, we believe that the indication of the emergency brake is appeared. At this time, the “pre-warning control signal” is generated by the PW-ECU and then the control signal controls the pre-warning devices to send pre-warning signal to the following vehicle. The invention is based on this point and puts forward that using the “pre-warning fuel-decreasing” method to solve the “deceleration pre-warning” problem.

The computer is used in the fuel injection and pre-warning system, thus the system has the following advantages: (1) data sharing can be realized. With this feature, the sampling value of the throttle sensor not only can be used for the fuel injection quantity calculations, but also can be used to fuel-decreasing pre-warning calculation while the system performance cannot be affected; (2) the existent data can be processed and modified. Therefore, the sampling value that comes from the throttle sensor can have the time differentiation operation and then we can get the throttle speed value.

### ADVANTAGES OF THE INVENTNION

1. The pre-warning effect is excellent. The method put forwarded by the invention is that sample from the output value of the throttle sensor that can detects the driver's attempt as earlier as possible and the pre-warning signals are calculated and processed by the high speed computer. Therefore the method disclosed in this invention can generate the pre-warning signals earlier than other methods. The leading vehicle will send the pre-warning signal to the following vehicle as soon as the leading vehicle's driver wants to lift the acceleration pedal in an emergency situation; so the method can effectively avoid the rear end collision accidents of vehicles.

2. The cost is low. In the invention, it is not necessary to buy and install new throttle sensor because the existent throttle sensor of the electric fuel injection system can be used to get the pre-warning signal. Therefore that the system cost can be reduced.

3. The security and reliability of the fuel-decreasing pre-warning system are improved because there are no motion parts in the system.

4. The throttle sensors for all kinds of the electric fuel injection system are standardized. Therefore, the method disclosed in this invention can be used widely and popularized.

5. The complex and emergency situations can be processed with high speed because the system is computerized and intelligent.

The important terms used in this invention are explained as the following:
(1) “throttle sensor”, it can be the electric accelerator pedal sensor, the throttle position sensor or the air flow meter.
(2) “throttle value”, it refers to the sampling value from the throttle sensor. The value can represent the output value of the throttle sensor during the sampling time. In the invention, throttle value can be expressed by the letter D.
(3) “throttle speed”, it means the rate of the change of the throttle value with the time. The throttle speed value can be obtained by the time differentiation operation to throttle value. In the invention, the value can be signified by the letter Rₜ.
(4) preset fuel-decreasing pre-warning value or called as preset value. In this invention, this preset value can be signified by the letter Rₚ. Its physics meaning is that the vehicle may have an emergency brake when the engine is decreasing the fuel and the throttle speed value Rₜ is equal to or exceed the preset value Rₚ when the engine decreases the fuel. At this time, the pre-warning devices of the leading vehicle will send the pre-warning signals to the following vehicle.
(5) Pre-warning devices. The pre-warning devices mentioned in this invention at least include the brake lights as well as the sound warning device and the wireless warning device.

Technique Schemes

The hardware system used to realize the method of preventing rear end collision of vehicles at least should include a throttle sensor of the electric fuel injection system, a PW-ECU which concerned with the throttle sensor, a electric switch installed between positive electrode of power supply and pre-warning devices and the electric switch is controlled by the PW-ECU, also a pre-warning devices controlled by the electric switch. Under the controlling of PW-ECU, the following operations should be executed in this hardware system for implementing the method for preventing rear end collision of vehicles:

(a) Sampling to the throttle sensor of the electric fuel injection system to get the throttle value D;

(b) Getting the throttle speed Rₜ by time differential operation to throttle value D;

(c) Comparing the throttle speed Rₜ with the preset Rₚ; The pre-warning control signal can be obtained when the comparative result can meet the pre-warning control conditions;

(d) The pre-warning control signal will drive the electric switch turned on and then the pre-warning devices will send out the pre-warning signal to the following vehicles.

The type of the fuel-decreasing pre-warning electric control unit in this invention can be the digital type or the analog type or the digital-analog type. There are digital method and analog method and digital-analog method according to the different type of the fuel-decreasing pre-warning electric control unit.

Digital Method for the Fuel-Decreasing Pre-Warning

The following procedures should be finished under the control of the PW-ECU whose core is a microcomputer.

(a) Getting the throttle value D through sampling from the throttle sensor;

The driver will frequently change the status of the throttle through control the accelerator pedal during the vehicle's travel. So the sampling value D from throttle sensor will also changed along with the time.

The throttle sampling value D will be stored into the throttle register Dₜ according to the time sequence; and the corresponding time t will be stored into the register Tₒ. After the Δt, the throttle value D of the t+Δt time will be stored into the throttle register D_{t+Δt} and the corresponding sampling time t+Δt will be stored into the register Tₜ. Before next step begin, the data in the register D_{t+Δt} will be transferred into the register Dₜ and the data in the register Tₜ will be transferred to the register Tₒ. And this is to make preparation for the throttle register D_{t+Δt} and the time register Tₜ to receive the new sampling data in the next step. If the output value of the throttle sensor is analog, the analog value should be converted to the digital value through the A/D analog-digital convertor.
Dₜ—the leading sampling register of the throttle value;
Tₒ—the leading sampling time register;
D_{t+Δt}—the current sampling register of the throttle value;
Tₜ—the current sampling time register.

(b) The throttle speed Rₜ can be obtained through the following operations under the control of the computer of the electric control unit.
(1) The calculation for the time step length
   Δt=Tₜ−Tₒ;
(2) The calculation for the sampling values of the two sampling
   ΔDₜ=D_{t+Δt}−Dₜ;
(3) The calculation for the throttle speed
   Rₜ=ΔDₜ/Δt;

From the above-mentioned sections, we can see that Rₜ is an arithmetical value and it has the following physic meanings:

If Rₜ is a positive number, namely Rₜ>0, this indicates that the throttle becomes bigger and bigger and the vehicle will accelerate;

If Rₜ is a negative number, namely Rₜ<0, this indicates that the throttle becomes smaller and smaller and the vehicle will decelerate;

If Rₜ is equal to zero, namely Rₜ=0, this indicates that the throttle will hold current status and the vehicle will keep current speed;

Additionally, the absolute value of Rₜ will indicate the change speed of the throttle.

During engine fuel-decreasing, the value of the throttle speed Rₜ can indicate the emergency degree of the situation that the driver encounters. If the situation is much more urgent, the fuel-decreasing speed is more quickly and the arithmetical value of Rₜ is more little.

(c) Comparing the throttle speed Rₜ with the preset value Rₚ under the computer control of the PW-ECU:
If Rₜ≦Rₚ;

Then we believe that the pre-warning condition is met and the computer will send the pre-warning instruction. And herein the pre-warning instruction means the pre-warning control signal.

(d) The computer will send the pre-warning instruction and then the instruction will control the electric switch turned on and finally the pre-warning device will send out the pre-warning signal;

The computer procedure can be “fixed pre-warning time length” type.

The computer is comparing the throttle speed Rₜ with the preset value Rₚ, when Rₜ≦Rₚ appear, then the preset pre-warning time length tₚ will be copied into the time register Lₜ and then the computer will send the pre-warning instruction to control the electric switch will turn on and finally the pre-warning devices will send out the pre-warning signals.

Hereafter, during every step length Δt, the step length Δt will be subtracted from the register Lₜ and then the computer will inquire the register Lₜ. If t>0, the pre-warning devices will keep sending out the pre-warning signals. And if Lₜ≦0, the computer will send out not pre-warning instructions and the pre-warning devices will not send out the pre-warning signals.

“Fixed pre-warning time length” can use the following procedures in the computer:

1. Power on and initialize the registers;

2. The time value of the moment should be stored to the register Tₜ at the beginning of every time step;

3. Calculating the time step length
Δt=Tₜ−Tₒ;

4. Inquiring the pre-warning time register Lₜ:
If Lₜ>0, the program skip to 11;
If Lₜ≦0, the program skip to 5;

5. Sampling from throttle sensor and the sample value D should be stored into the register D_{t+Δt};

6. Calculating the difference of the two sample values of the throttle,
ΔDₜ=D_{t+Δt}−Dₜ;

7. Calculating the throttle speed Rₜ.
Rₜ=ΔDₜ/Δt;

8. Comparing Rₜ with Rₚ and then analyze the result:
If Rₜ>Rₚ, the program skip to 9;
If Rₜ≦Rₚ, the program skip to 10;

9. Set the pre-warning time register Lₜ=0, the pre-warning device will not send the pre-warning signals and the program skip to 12;

10. Set the pre-warning time register Lₜ=tₚ, the pre-warning device will send the pre-warning signals and the program skip to 11;

11. The sampling step length Δt will be subtracted from the register Lₜ and then the program skip to 12;

12. The value in the current throttle register D_{t+Δt} should be transferred into the leading throttle registers Dₜ. And this is to make preparation for the register D_{t+Δt} to receive new sampling value;

13. The current value in the time register Tₜ should be transferred into the time register Tₒ. And this is to make preparation for the register Tₜ to receive new sampling values;

14. The program will return to 2.

The computer procedure can be stepping pre-warning type.

In the stepping pre-warning type, the throttle speed value Rₜ will be calculated in every time step, and the throttle speed Rₜ will compare with the preset value Rₚ, and then the comparison result will determine whether the brake lights to be lighting. If the throttle speed Rₜ cannot meet the pre-warning conditions, the pre-warning devices will not send the pre-warning signals no matter what value the Lₜ is. Additionally, we also should consider if the throttle is on the idle speed status during calculation the accelerator speed.

“Stepping pre-warning” type in the computer can use the following procedures:

S100: Power on and initialize the registers;

S102: The time value of the moment should be stored into the register Tₜ;

S104: Calculating the step length of sampling time
Δt=Tₜ−Tₒ;

S110: The current throttle sampling value D should be stored into the throttle register D_{t+Δt};

S112: Calculating the difference of the two sampling values of the throttle:
ΔDₜ=D_{t+Δt}−Dₜ;

S114: calculating the throttle speed
Rₜ=ΔDₜ/Δt;

S130: Comparing Rₜ with the preset value Rₚ and then analyze the result:
If Rₜ≦Rₚ program should skip to S132;
If Rₜ>Rₚ program should skip to S138;

S132: Setting the pre-warning time register Lₜ=tₚ, and the program skip to S152;

S138: Inquire the idle switch's status IDL:
If IDL=0, that indicates the accelerator is not on the idle status and the program skip to S139;
If IDL=1, that indicates the accelerator is on the idle status and the program skip to S150;

S139: Setting the pre-warning time register Lₜ=0, the program skip to S154;

S150: Inquire the pre-warning time register Lₜ:
If Lₜ>0, the program skip to S152;
If Lₜ≦0, the program skip to S154;

S152: The computer will send the pre-warning instructions and the pre-warning device will send the pre-warning signals and finally the program skip to S156;

S154: The computer will send the not pre-warning instruction, the pre-warning device will not send the pre-warning signals and the program skip to S160;

S156: The current Δt will be subtracted from the Lₜ and then the program skip to S160;

S160: The value in the register D_{t+Δt} will be transferred into the register Dₜ, and the program skip to S162;

S162: The value in the register Tₜ will be transferred into the register Tₒ and the program skip to S102;

The electric switch in the invention can be the high-power semiconductor switch or the high-power relay.

The pre-warning devices used in this invention can be the brake light, sound warning devices or the wireless warning device.

Analog Method for the Fuel-Decreasing Pre-Warning:

This analog method can be realized through the analog fuel-decreasing pre-warning electric control unit named as APW-ECU. The hardware system includes at least the throttle sensor of the electric fuel injection system, the APW-ECU concerned with the throttle sensor, the electric switch connected with the APW-ECU and the pre-warning devices controlled by the electric switch.

The APW-ECU is consisted with the voltage follower, voltage differential circuit, voltage comparator and the pre-warning timing circuit. The connection between the four parts and the signal transfer process between the four parts are explained as the following:

(a) The input port of the voltage follower is connected with the output port of the throttle sensor. The output voltage value of the throttle sensor can be got from the output port of the voltage follower and the output voltage value of the voltage follower equal to the output voltage value D of throttle sensor. The connection will not affect the normal operation of the electric fuel injection system because the voltage follower has the high input resistance characteristics;

(b) The input port of the analog voltage differential circuit should connect to the output port of the voltage follower. The output voltage of the voltage follower will be done the differentiation operation through the voltage differential circuit. The output voltage of the voltage differential circuit can represent the throttle speed Rₜ;

(c) The output port of the voltage differential circuit should be connected to one input port of the analog voltage comparator. The direct current electric voltage represented the preset value Rₚ should be connected to another input port of the analog voltage comparator. And then the throttle speed voltage Rₜ of the output port of the voltage differential circuits will compare with the preset value Rₚ through the comparator. If the throttle speed voltage Rₜ is equal with the preset value Rₚ, the output voltage of the comparator will jump to a new value and the value is the fuel-decreasing pre-warning control signal;

(d) The input trigger port of the timing circuit should be connected to the output port of the comparator. The control terminal of the electric switch should be connected to the output port of the timing circuit. The timing circuit will be trigger to the normal operation status when the output voltage of the comparator jumps; and at the same time the output voltage of the timing circuit will also jump to a new value and then the electric switch will be turn on and finally the pre-warning device will send the pre-warning signals. When the preset pre-warning time is finished, the output voltage of the timing circuit will jump to the original value. And then the original value will drive the electric switch turn off and the pre-warning device will not send the pre-warning signal.

Digital-Analog Method of Fuel-Decreasing Pre-Warning:

The first generation of the computer is the analog type and later the digital type is generated but at the same time the analog-digital type has been manufactured. So the PW-ECU can be consisted with the digital-analog module. It can be The analog value can be converted to digital value by the analog-digital converter or the digital value can be converted to analog value by the digital-analog converter.

### BRIEF DESCRIPTION OF DRAWINGS

FIG. 1 is a principle block diagram for the fuel-decreasing pre-warning method.

FIG. 2 is a block diagram of the digital fuel-decreasing pre-warning system.

FIG. 3 is conjunction block diagrams between PW-ECU 22, electric switch 6, brake lights 7 and brake switch 61.

FIG. 4 is a flow chart used for fixed pre-warning time length program.

FIG. 5 is a flow chart used for stepping pre-warning program.

FIG. 6 is a block diagram of the analog fuel-decreasing pre-warning system.

FIG. 7 is an electric circuit diagram for the analog fuel-decreasing pre-warning system.

### EMBODIMENT 1

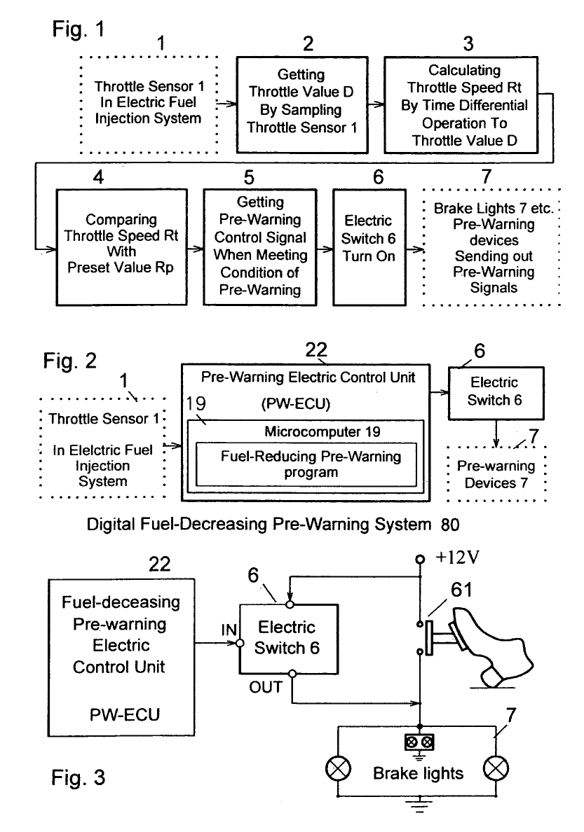

Referring to FIG. 1 and FIG. 2, a method for preventing rear end collision of vehicles is put forwarded in the embodiment 1. The PW-ECU comprises the microcomputer 19 installed with the fuel-decreasing pre-warning program. According to the instructions of pre-warning program, the microcomputer 19 samples from the throttle sensor 1 to get the throttle value D; and then the throttle speed Rₜ will be got through carrying out time differential operations to throttle value D. After that, the throttle speed Rₜ will compared with the preset value Rₚ. If the comparing result meets the pre-warning conditions, the microcomputer 19 will send the pre-warning instructions to make the electric switch 6 turned on and then the pre-warning devices will send the pre-warning signals. In the embodiment 1, the pre-warning device is the brake lights 7.

In this embodiment 1, the hardware system used to realize the method at least should include the following parts:

A PW-ECU comprising the microcomputer 19 installed with the fuel-decreasing pre-warning program.

A throttle sensor 1 of the electric fuel injection system. The throttle sensor 1 is connected to one preset input port of the microcomputer 19.

An electric switch 6 installed between Positive electrode of power supply and the brake lights 7 and controlled by the microcomputer 19.

A group of brake lights 7 controlled by the electric switch 6.

The throttle sensor 1 and the brake lights 7 are the original equipments of the vehicles but the microcomputer 19 and the electric switch 6 is the new added equipment.

The important thing of finishing the fuel-decreasing pre-warning task is to install the fuel-decreasing pre-warning program into the microcomputer 19.

The fuel-decreasing pre-warning program is the instruction sets written in the computer language and the instructions are executed by the hardware of the computer. The microcomputer 19 will carry out the fuel-decreasing pre-warning program in order to complete the fuel-decreasing pre-warning operations below:

(1) Sampling from the throttle sensor 1 to get the throttle value D;

(2) Do the time differential operation to the throttle value D to get the throttle speed Rₜ;

(3) Comparing the throttle speed Rₜ with the preset value Rₚ; If the comparing result meets the pre-warning requirement, the microcomputer 19 will send out the pre-warning instructions;

(4) The pre-warning instructions will control the electric switch 6 to turn on and then the brake lights 7 will lighted, When the preset time for brake light lighting is finished, the microcomputer 19 will send not pre-warning instruction to control the electric switch 6 turned off and then the brake lights will go out.

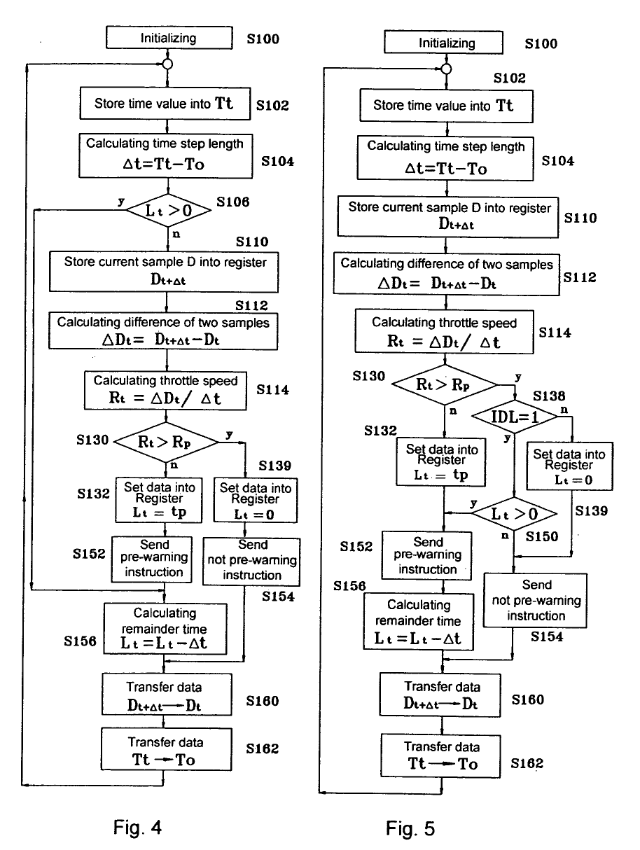

In this embodiment 1, the type of the pre-warning program can be “fixed pre-warning time length” style. That is to say, the lighting time for the brake light 7 is constant. The microcomputer 19 executes the pre-warning program shown in FIG. 4 to realize the method for preventing rear end collision of vehicles.

S100: Power on and initializing registers;

S102: The time value should be stored into the register Tₜ;

S104: Calculating the time step length
Δt=Tₜ−Tₒ;

S106: Inquiring the pre-warning time register Lₜ,
If Lₜ>0, the program will direct skip to S156,
That means the computer has sent the pre-warning instruction in the former time step and the brake lights 7 is still lighting and the pre-warning time has not been finished. At this moment, the program will direct turn to S156 instead of running the calculation section of fuel-decreasing speed Rₜ and comparing section;
   If Lₜ≦0, the program skip to S110 and beginning to calculate throttle speed Rₜ;

S110: Sampling from the throttle sensor and then the current throttle value D will be stored to the throttle register D_{t+Δt};

S112: Calculating the difference of the throttle's two sampling values,
ΔDₜ=D_{t+Δt}−Dₜ;

S114: Calculating the throttle speed Rₜ,
Rₜ=ΔDₜ/Δt;

S130: Comparing the throttle speed Rₜ with the preset value Rₚ and then to determine if the emergency fuel-decreasing condition is came out,
If Rₜ≦Rₚ, that means the vehicle is on the emergency fuel-decreasing process and the program will skip to S132,
If Rₜ>Rₚ, that means the emergency fuel-decreasing condition did not appear and the program skip to S139,

S132: Set the preset pre-warning time tₚ into the pre-warning time register Lₜ, set the Lₜ=tₚ, and then the program skip to S152;

S139: Set Lₜ=0, and then the program skip to S154;

S152: The computer sends the pre-warning instructions to control the electric switch turn on and then the brake lights will lighting and finally the program skip to S156

S154: The computer will send out the not pre-warning instructions and the electric switch will turn off and the brake lights will go out and finally the program skip to S160;

S156: Calculating remainder time of the pre-warning, Lₜ=Lₜ−Δt, program skip to S160;

S160: The current throttle sampling value D_{t+Δt} will be transferred into the register Dₜ to make preparation for the next new time step, the program skip to S162;

S162: The current time value Tₜ should be transferred into the register Tₒ to make preparation for the next new time step. The program skips to S102.

### EMBODIMENT 2

In this embodiment, the “stepping pre-warning” method is used that means the lighting time of the brake lights 7 is not constant and can be changed. The lighting time of the brake lights is determined by the value in the time register Lt in every time step, the throttle speed value Rt and the IDL status of the idle switch of the engine IDL (IDL=0, that means the throttle is not at the idle speed status; IDL=1, that means the throttle is on the idle speed status).

In this embodiment, the “stepping pre-warning” program style can be realized through executing the program shown in the FIG. 5 by the computer 19:

S100: Power on and initializing the registers;

S102: Storing the current time value to the register Tₜ;

S104: Calculating the time step length
Δt=Tₜ−Tₒ;

S110: Sampling from the throttle sensor and then the current throttle value D will be stored to the throttle register D_{t+Δt};

S112: Calculating the differences of the two throttle sampling values
ΔDₜ=D_{t+Δt}−Dₜ;

S114: Calculating the throttle speed
Rₜ=ΔDₜ/Δt;

S130: Comparing Rₜ with the preset value Rₚ and then analyze the result:
If Rₜ≦Rₚ the program skip to S132;
If Rₜ>Rₚ the program skip to S138;

S132: Set the pre-warning time register Lₜ=tₚ, and then the program skip to S152;

S138: Inquire the idle switch status IDL:
If IDL=0, that means the throttle is not at the idle status and then the program skip to S139;
If IDL=1, that means the throttle is at the idle status and then the program skip to S150;

S139: Set the pre-warning time register Lₜ=0 and then the program skip to S154;

S150: Inquire the pre-warning time register Lₜ:
If Lₜ>0, the program skip to S152;
If Lₜ≦0, the program skip to S154;

S152: The computer will send the pre-warning instruction and the pre-warning devices will send out the pre-warning signals and finally the program skip to S156;

S154: The computer will send not pre-warning instruction and the pre-warning devices will not send the pre-warning signals and finally the program skip to S160;

S156: Calculating remainder time of the pre-warning,
Lₜ=Lₜ−Δt,
the program skip to S160;

S160: the value in the register D_{t+Δt} will be transferred into the register Dₜ and then the program skip to S162;

S162: The value in the register Tₜ will be transferred into the register Tₒ and then the program skip to S102.

The embodiment 2 has the following advantages:

(1) The false triggering can be eliminated effectively. The false triggering that happened in one time step can be corrected in the next time step and the pre-warning can be ceased instantly. There will be no interference because the period of every cycle is too short.

(2) When the driver finds the emergency situation, he/she will decrease the fuel quickly and at the same time the brake light will be lighted. But when the emergency situation disappeared, the driver will increase the fuel and at the same time the not pre-warning signal is sent out and the brake lights will turn off.

### EMBODIMENT 3

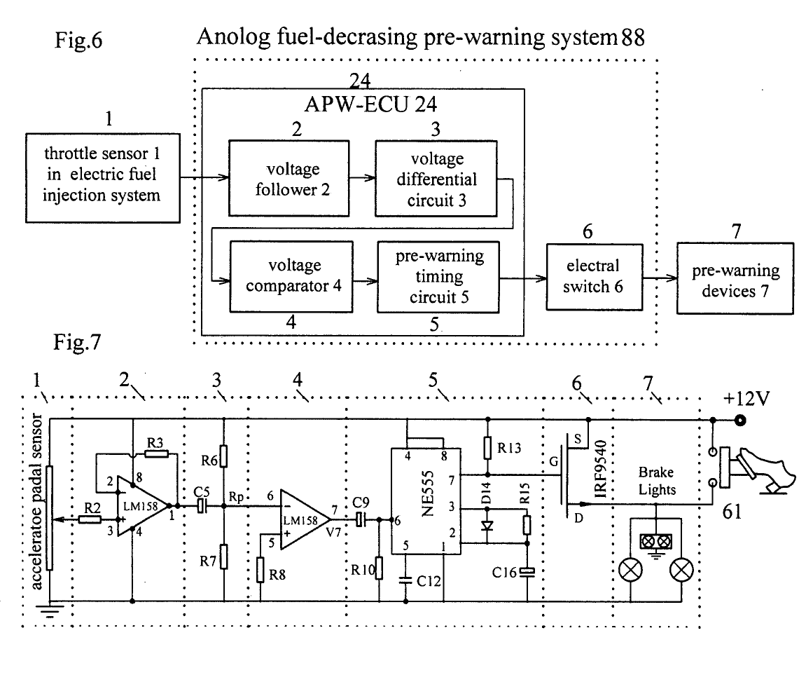

Please refer to FIG. 6 and FIG. 7:

A system for preventing rear end collision of vehicles is applied for vehicles with electric fuel injection system, which comprises at least:
(1) an analog fuel-decreasing pre-warning electric control unit 24 comprising a voltage follower 2, a voltage differential circuit 3, a voltage comparator 4 and a pre-warning timing circuit 5;
the input port of voltage follower 2 is connected to the output port of the throttle sensor 1 of the electric fuel injection system; the input port of the voltage differential circuit 3 is connected to the voltage output port of the voltage follower 2; one input port of voltage comparator 4 is connected to the voltage output port of the voltage differential circuit 3 and the another input port is connected to the preset voltage Rₚ, the input port of pre-warning timing circuit 5 is connected to the output port of voltage comparator 4;
an electric switch 6 installed between positive electrode of power supply and the pre-warning devices 7 and the input port of electric switch 6 is connected to the output port of the pre-warning timing circuit 5; thus the electric switch 6 is controlled by the analog fuel-decreasing pre-warning electric control unit and the pre-warning devices 7 is controlled by the electric switch 6; From FIG. 7, can find out that electric switch 6 is connected with foot brake switch 61 parallel.

Under the controlling of the analog fuel-decreasing pre-warning electric control unit 24, the following operations can be finished:
(a) sampling from the throttle sensor 1 of the electric fuel injection system to get the analog throttle voltage D by the voltage follower 2;
(b) do the time differentiation operation to the analog throttle voltage D to get the analog voltage Rₜ of the throttle speed by the voltage differential circuit 3;
(c) comparing the analog voltage Rₜ of the throttle speed with the preset voltage Rₚ, when the pre-warning control condition is met, the pre-warning control signal will be generated by the voltage comparator 4;
(d) the pre-warning control signal will drive the electric switch 6 turned on, then the pre-warning devices 7 will send out the pre-warning signals to the following vehicles.

The voltage follower 2 is consisted with a integrated operational amplifier LM158 and resistor R2 and R3; one end of the resistor R2 is connected to the positive input port 3 of the LM158 and the another end of the resistor R2 is connected to the output port of the throttle sensor 1, here, the electric accelerator pedal sensor is used as the throttle sensor 1; one end of the resistor R3 is connected to the negative input port 2 of the LM158 and another end of the resistor R3 is connected to the output port 1 of the LM158, the output voltage of the voltage follower 2 can follow the output voltage of the throttle sensor 1 in real time.

The differential circuit 3 is consisted with the capacitor C5, resistor R6 and resistor R7; one end of the resistor R6 is connected with the positive power supply and the other end of the resistor R6 is connected with one end of the resistor R7 and the another end of the resistor R7 is connected with ground; the positive end of the capacitor C5 is connected to the output port 1 of the LM158 and the another end of the capacitor C5 is connected to cross point of the resistor R6 and resistor R7; the positive end of the capacitor C5 is the input end of the differential circuit 3; the negative side of the capacitor C5 is the output end of the differential circuit 3;

The voltage comparator 4 is consisted with analog integrated circuit LM158 and the resistor R8, the positive input port 5 of the LM158 is connected to ground through the resistor R8 and the negative input port 6 of the LM158 is connected to the cross point of the resistor R6 and resistor R7 and the negative input port 6 of the LM158 is the input port of the voltage comparator 4 and the port 7 of the LM158 is the output port of the voltage comparator 4; the output voltage of the voltage follower 2 will be underwent the differential operation in the differential circuit 3 and then the differential result will sum with the preset voltage Rₚ, if the voltage of the input port 6 of the LM158 equals to 0 or less 0, the output level of the voltage comparator 4 will jump from the low voltage to high positive voltage and this jump voltage is the pre-warning control signal.

The pre-warning timing circuit 5 is consisted with the time-base circuit EN555, capacitor C9, C12 and C16, resistor R10, R13 and R15 and the diode D14; the positive end of capacitor C9 is connected to the output port of the voltage comparator 4; its negative end is connected to the threshold port 6 of NE555; one end of resistor R10 is connected to the threshold port 6 of NE555 and its another end is connected with ground; port 4 and port 8 of NE555 is connected to positive electrode of power supply; port 1 of NE555 is connected with ground; port 5 of NE555 is connected with ground through capacitor C12; port 7 of NE555 is connected with positive electrode of power supply through resistor R13; one end of resistor R15 and positive end of diode 14 are connected to port 3 of NE555; other ends of the R15 and diode 14 are connected to port 2 of NE555; positive end of capacitor C16 is connected to port 2 of NE555 and its negative end is connected with ground; it is a typical monostable timing circuit with a positive trigger and negative output; the input port of the timing circuit 5 is the threshold port 6 of NE555; the output port of the timing circuit 5 is the discharge port 7 of NE555;

The electric switch 6 is a high power semiconductors switch IRF9540, the gate electrode G of the IRF9540 is connected to the output port of the timing circuit 5 and the source electrode S of the IRF9540 is connected to the positive electrode of the power supply of the vehicles' system and its drain electrode D of the IRF9540 is connected to the positive power end of the brake lights.

The electric accelerator pedal sensor can be used as the throttle sensor 1.

The throttle valve position sensor can be used as the throttle sensor 1.

The air flow meter can be used as the throttle sensor 1.

1. A method for preventing rear end collision of vehicles, when implementing this method the hardware system of needs should include at least four parts: (1) The throttle sensor 1 of the electric fuel injection system; (2) The fuel-decreasing pre-warning electric control unit 22 concerned with the throttle sensor 1; (3) The electric switch 6 installed between the positive electrode of power supply and the pre-warning devices 7 and controlled by the fuel-decreasing pre-warning electric control unit 22 named as PW-ECU 22; (4) The pre-warning devices 7 controlled by the electric switch 6; Under the controlling of PW-ECU 22, the following operations should be executed in the hardware system for implementing this method for preventing rear end collision of vehicles:
a. Sampling from the throttle sensor of the electric fuel injection system and then get the throttle value D;
b. Do the time differentiation operation to the throttle value D and then get the throttle speed Rₜ;
c. Comparing the throttle speed value Rₜ with the preset value Rₚ; when the comparative result can meet the pre-warning control conditions, we can get the pre-warning control signal;
d. The pre-warning control signal will control the electric switches to turn on and then the pre-warning devices will send out the pre-warning signals to the following vehicle.

2. The method for preventing rear end collision of vehicles as in claim 1, the pre-warning control conditions can be the following:
If Rₜ≦Rₚ, the pre-warning control signal can be generated,
If Rₜ>Rₚ, the pre-warning control signal can not be generated.

3. The method for preventing rear end collision of vehicles as in claim 1, in which the fuel-decreasing pre-warning programs installed into the digital computer of the fuel-decreasing pre-warning electric control unit is used for executing the fuel-decreasing pre-warning operations listed from (a) to (d).

4. The method for preventing rear end collision of vehicles as in claim 3, the fuel-decreasing pre-warning programs can be “fixed pre-warning time length” style; And through the following operations by the microcomputer 19 the fuel-decreasing pre-warning target can be achieved:
S100: Power on and initializing the registers;
S102: Storing the time value into the register Tₜ;
S104: Calculating the time step length
Δt=Tₜ−Tₒ;
S106: Inquiring the pre-warning time register Lₜ;
If Lₜ>0, program will direct skip to S156;
If Lₜ≦0, program skip to S110;
S110: Sampling from the throttle sensor and then the current throttle value D will be stored into the throttle register D_{t+Δt};
S112: Calculating the difference of the two throttle sampling values,
ΔDₜ=D_{t+Δt}−Dₜ;
S114: Calculating the throttle speed Rₜ,
Rₜ=ΔDₜ/Δt;
S130: Comparing the throttle speed Rₜ with the preset value Rₚ,
If Rₜ≦Rₚ, that means the vehicle is on the fuel-decreasing process and the program skip to S132;
If Rₜ>Rₚ, that means the emergency fuel-decreasing condition is came out and the program skip to S139;
S132: Read the preset pre-warning time tₚ into the pre-warning time register Lₜ, set the Lₜ=tₚ, and then the program skip to S152;
S139: Set Lₜ=0, and then the program skip to S154;
S152: The computer sends the pre-warning instructions and then the instruction will control the electric switch turn on and then the brake lights will lighting and finally the program skip to S156;
S154: The computer will send out the not pre-warning instructions and the electric switch will turn off and the brake lights will go out and finally the program skip to S160;
S156: Calculating remainder time of the pre-warning,
Lₜ=Lₜ−Δt, program skip to S160;
S160: The current throttle sampling value D_{t+Δt} will be transferred into the register Dₜ, program skip to S162;
S162: The current time value Tₜ should be transferred into the register Tₒ, program skip to S102.

5. The method for preventing rear end collision of vehicles as in claim 3, the fuel-decreasing pre-warning programs can be “stepping pre-warning time length” style; And through the following operations, the fuel-decreasing pre-warning target can be achieved:
S100: Power on and initializing the registers;
S102: Storing the current time value into the register Tₜ;
S104: Calculating the time step length
Δt=Tₜ−Tₒ;
S110: Sampling from the throttle sensor and then the current throttle value D will be stored into the throttle register D_{t+Δt};
S112: Calculating the differences of the two throttle sampling values
ΔDₜ=D_{t+Δt}−Dₜ;
S114: Calculating the throttle speed
Rₜ=ΔDₜ/Δt;
S130: Comparing Rₜ with the preset value Rₚ and then analyze the result;
If Rₜ≦Rₚ program skip to S132;
If Rₜ>Rₚ program skip to S138;
S132: Set the pre-warning time register Lₜ=tₚ, and then the program skip to S152;
S138: Inquire the idle switch status IDL,
If IDL=0, program skip to S139;
If IDL=1, program skip to S150;
S139: Set the pre-warning time register Lₜ=0 and then the program skip to S154;
S150: Inquire the pre-warning time register Lₜ,
If Lₜ>0, program skip to S152;
If Lₜ≦0, program skip to S154;
S152: The computer will send the pre-warning instruction and the pre-warning devices will send the pre-warning signals and finally program skip to S156;
S154: The computer will send not pre-warning instruction and the pre-warning devices will not send the pre-warning signals and finally the program skip to S160;
S156: Calculating remainder time of the pre-warning,
Lₜ=Lₜ−Δt, program skip to S160;
S160: the value in the register D_{t+Δt} will be transferred into the register Dₜ and then the program skip to S162;
S162: The value in the register Tₜ will be transferred into the register Tₒ and then the program skip to S102.

6. A system for preventing rear end collision of vehicles is applied for a vehicles with electric fuel injection system, which comprises at least:
(1) an analog fuel-decreasing pre-warning electric control unit 24 comprising a voltage follower 2, a voltage differential circuit 3, a voltage comparator 4 and a pre-warning timing circuit 5; the input port of voltage follower 2 is connected to the output port of the throttle sensor 1 of the electric fuel injection system; the input port of the voltage differential circuit 3 is connected to the voltage output port of the voltage follower 2; one input port of voltage comparator 4 is connected to the voltage output port of the voltage differential circuit 3 and the another input port is connected to the preset voltage Rₚ, the input port of pre-warning timing circuit 5 is connected to the output port of voltage comparator 4;
(2) an electric switch 6 installed between positive electrode of power supply and the pre-warning devices 7 and the input port of electric switch 6 is connected to the output port of the pre-warning timing circuit 5; thus the electric switch 6 is controlled by the analog fuel-decreasing pre-warning electric control unit 24 and the pre-warning devices 7 is controlled by the electric switch 6; under the controlling of the analog fuel-decreasing pre-warning electric control unit 24, the following operations can be finished:
(a) sampling from the throttle sensor 1 of the electric fuel injection system to get the analog throttle voltage D by the voltage follower 2;
(b) do the time differentiation operation to the analog throttle voltage D to get the analog voltage Rₜ of the throttle speed by the voltage differential circuit 3;
(c) comparing the analog voltage Rₜ of the throttle speed with the preset voltage Rₚ, when the pre-warning control condition is met, the pre-warning control signal will be generated by the voltage comparator 4;
(d) the pre-warning control signal will drive the electric switch 6 turned on, then the pre-warning devices 7 will send out the pre-warning signals to the following vehicles.

7. The system for preventing rear end collision of vehicles as in claim 6, the voltage follower 2 is consisted with a integrated operational amplifier LM158 and resistor R2 and R3; one end of the resistor R2 is connected to the positive input port 3 of the LM158 and the another end of the resistor R2 is connected to the output port of the throttle sensor 1, here, the electric accelerator pedal sensor is used as the throttle sensor 1; one end of the resistor R3 is connected to the negative input port 2 of the LM158 and another end of the resistor R3 is connected to the output port 1 of the LM158, the output voltage of the voltage follower 2 can follow the output voltage of the throttle sensor 1 in real time.

8. The system for preventing rear end collision of vehicles as in claim 6, the differential circuit 3 is consisted with the capacitor C5, resistor R6 and resistor R7; one end of the resistor R6 is connected with the positive power supply and the other end of the resistor R6 is connected with one end of the resistor R7 and the another end of the resistor R7 is connected with ground; the positive end of the capacitor C5 is connected to the output port 1 of the LM158 and the another end of the capacitor C5 is connected to cross point of the resistor R6 and resistor R7; the positive end of the capacitor C5 is the input end of the differential circuit 3; the negative side of the capacitor C5 is the output end of the differential circuit 3.

9. The system for preventing rear end collision of vehicles as in claim 6, the voltage comparator 4 is consisted with analog integrated circuit LM158 and the resistor R8, the positive input port 5 of the LM158 is connected to ground through the resistor R8 and the negative input port 6 of the LM158 is connected to the cross point of the resistor R6 and resistor R7 and the negative input port 6 of the LM158 is the input port of the voltage comparator 4 and the port 7 of the LM158 is the output port of the voltage comparator 4; the output voltage of the voltage follower 2 will be underwent the differential operation in the differential circuit 3 and then the differential result will sum with the preset voltage Rₚ, if the voltage of the input port 6 of the LM158 equals to 0 or less 0, the output level of the voltage comparator 4 will jump from the low voltage to high positive voltage and this jump voltage is the pre-warning control signal.

10. The system for preventing rear end collision of vehicles as in claim 6, the pre-warning timing circuit 5 is consisted with the time-base circuit EN555, capacitor C9, C12 and C16, resistor R10, R13 and R15 and the diode D14; the positive end of capacitor C9 is connected to the output port of the voltage comparator 4; its negative end is connected to the threshold port 6 of NE555; one end of resistor R10 is connected to the threshold port 6 of NE555 and its another end is connected with ground; port 4 and port 8 of NE555 is connected to positive electrode of power supply; port 1 of NE555 is connected with ground; port 5 of NE555 is connected with ground through capacitor C12; port 7 of NE555 is connected with positive electrode of power supply through resistor R13; one end of resistor R15 and positive end of diode 14 are connected to port 3 of NE555; other ends of the R15 and diode 14 are connected to port 2 of NE555; positive end of capacitor C16 is connected to port 2 of NE555 and its negative end is connected with ground; it is a typical monostable timing circuit with a positive trigger and negative output; the input port of the timing circuit 5 is the threshold port 6 of NE555; the output port of the timing circuit 5 is the discharge port 7 of NE555.

11. The system for preventing rear end collision of vehicles as in claim 6, the electric switch 6 is a high power semiconductors switch IRF9540, the gate electrode G of the IRF9540 is connected to the output port of the timing circuit 5 and the source electrode S of the IRF9540 is connected to the positive electrode of the power supply of the vehicles' system and its drain electrode D of the IRF9540 is connected to the positive power end of the brake lights.

12. The system for preventing rear end collision of vehicles as in claim 6, the electric accelerator pedal sensor in electric fuel injection system can be used as the throttle sensor 1.

13. The system for preventing rear end collision of vehicles as in claim 6, the throttle valve position sensor in electric fuel injection system can be used as the throttle sensor 1.

14. The system for preventing rear end collision of vehicles as in claim 6, the air flow meter in electric fuel injection system can be used as the throttle sensor 1.
